(19) United States
(12) Patent Application Publication
(10) Pub. No.: US 2024/0080153 A1
(43) Pub. Date: Mar. 7, 2024

(54) METHOD AND APPARATUS FOR TRANSMITTING AN INFORMATION IN A WIRELESS COMMUNICATION SYSTEM

(71) Applicant: SAMSUNG ELECTRONICS CO., LTD., Suwon-si (KR)

(72) Inventors: Di SU, Beijing (CN); Zhe CHEN, Beijing (CN); Chen QIAN, Beijing (CN)

(21) Appl. No.: 18/307,679

(22) Filed: Apr. 26, 2023

(30) Foreign Application Priority Data
Apr. 28, 2022 (CN) 202210470954.3

(51) Int. Cl. H04L 5/00; H04W 72/0446

(52) U.S. Cl. CPC H04L 5/0048; H04W 72/0446

(57) ABSTRACT

The disclosure relates to a 5G or 6G communication system for supporting a higher data transmission rate. Embodiments of the present application provide a method performed by a network controlled repeater (NCR) in a wireless communication system. The method includes receiving, by an NCR mobile terminal (NCR-MT) from a base station, control information; identifying a forwarding state of an NCR-amplifier and a resource corresponding to the forwarding state based on the control information: receiving, by the NCR-MT from the base station, a downlink signal; and forwarding, by the NCR-amplifier to a user equipment (UE), the downlink signal on the identified resource, in case that the forwarding state is a forwarding-on state.

### CROSS-REFERENCE TO RELATED APPLICATIONS

This application is based on and claims priority under 35 U.S.C. § 119 to Chinese Patent Application No. 202210470954.3 filed on Apr. 28, 2022, in the Chinese National Intellectual Property Administration, the disclosure of which is incorporated by reference herein in its entirety.

### BACKGROUND

### 1. Field

The present disclosure relates to the wireless communication system, and in particular to method and apparatus for an information transmission in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality). VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The present disclosure relates to wireless communication systems, and more specifically, the present disclosure relates to a method and apparatus for transmitting information in the wireless communication system.

### SUMMARY

Embodiments of the present disclosure relate to the method performed by a network device in a communication system, and a device, in order to solve at least one of the technical defects in the existing communication modes, further improve the wireless communication modes and better meet the actual communication requirements. For this purpose, the following technical solutions are employed.

According to an aspect of the present disclosure, there is provided method performed by a network device in a wireless communication system. The method includes receiving control information from a base station. Further, the method includes determining forwarding state and/or resource information based on the control information. Further, the method includes controlling the forwarding of signals based on the determined forwarding state and/or resource information.

In one embodiment, the forwarding state includes at least one of: uplink forwarding, downlink forwarding, forwarding on state, and forwarding off state.

In one embodiment, the determining the forwarding state and/or resource information based on the control information includes at least one of the following: determining, based on the control information, a frequency-domain resource corresponding to the forwarding state of uplink forwarding and/or downlink forwarding, determining, based on the control information, a time-domain resource corresponding to forwarding on and/or forwarding off, determining, based on the control information, the switching time between uplink forwarding and downlink forwarding, determining, based on the starting time and/or an uplink transmission timing advance, at least one of the actual starting time of uplink forwarding, the actual ending time of uplink forwarding, the actual starting time of downlink forwarding and the actual ending time of downlink forwarding, and determining, based on the control information, at least one of: an uplink forwarding time unit, a downlink forwarding time unit and an interval between an uplink forwarding time-domain symbol and a downlink forwarding time-domain symbol. Further, the uplink transmission timing advance is an uplink transmission timing advance of a mobile terminal that processes the control information in the network device.

In one embodiment, the control information includes indication information related to the frequency-domain resource, and the frequency-domain resource includes at least one of a carrier, a bandwidth part (BWP), a physical resource block group (RBG) and a physical resource block (PRB).

In one embodiment, the method includes the determining, based on the control information, a time-domain resource corresponding to forwarding on and/or forwarding off includes at least one of the following: determining the forwarding on time and/or the forwarding off time based on the indication information of the forwarding on time in the control information, determining the forwarding on time based on the indication information of triggering forwarding on in the control information, determining the forwarding off time based on the indication information of triggering forwarding off in the control information, determining the starting time of forwarding on and/or forwarding off based on the reception time of downlink control information and/or control information format in the control information, determining, based on the control information, a time unit for uplink forwarding and/or a time unit for downlink forwarding in the time of the forwarding state of forwarding on, and determining the uplink forwarding time, the downlink fowarding time and/or the forwarding off time based on the indication information of the uplink forwarding time and/or downlink fowarding time in the control information.

In one embodiment, the switching time includes at least one of: a first switching time from uplink forwarding to downlink fowarding and a second switching time from downlink forwarding to uplink forwarding.

In one embodiment, the switching time is related to the switching time related capability reported by the network device.

In one embodiment, the interval between the uplink forwarding time-domain symbol and the downlink forwarding time-domain symbol is at least one time unit or a time interval of a non-integer multiple of time domain symbols.

In one embodiment, the time-domain resource includes at least one time unit, and the time unit includes at least one of: a time-domain symbol, a slot, a half slot, a radio frame and a subframe.

In one embodiment, before the controlling the forwarding of a signal based on the determined forwarding state and/or resource information, the method further includes: determining the forwarding state based on the state of the mobile terminal that processes the control information in the network device.

In one embodiment, the network device includes a forwarder for forwarding signals and a mobile terminal for processing the control information. Further, the control information includes at least one of: first configuration information for the mobile terminal and second configuration information for the forwarder; and, when the control information includes the first configuration information and the second configuration information, there is an association relationship between the first configuration information and the second configuration information.

In one embodiment, the association relationship includes an association relationship between the parameter and/or state of the mobile terminal configured by the first configuration information and the forwarding state of the forwarder configured by the second configuration information.

In one embodiment, the control information is received by at least one of the following: receiving a high-layer signaling, receiving downlink control information, and receiving switching control information MAC CE.

In one embodiment, the downlink control information is downlink control information common to a user group or downlink control information exclusive to a user.

According to an aspect of the present disclosure, there is provided a method performed by a base station in a wireless communication system. The method includes acquiring control information. Further, the method includes transmitting the control information to a network device in the communication system, the control information being used for instructing the network device to determine forwarding state and/or resource information based on the control information and control the forwarding of signals based on the determined forwarding state and/or resource information.

In one embodiment, the acquiring control information includes configuring the control information. Further, the forwarding state comprises at least one of: uplink forwarding, downlink forwarding, forwarding on state, and forwarding off state.

In one embodiment, the configuring the control information includes receiving the switching time related capability reported by the network device, the switching time being a switching time between uplink forwarding and downlink forwarding, and configuring the control information based on the capability.

According to an aspect of the present disclosure, there is provided a network device in a wireless communication system. The network device includes a transceiver and a processor, which is coupled to the transceiver. The processor is configured to perform the operations corresponding to the method in the first aspect of the present disclosure.

According to an aspect of the present disclosure, there is provided a base station in a wireless communication system. The base station includes a transceiver and a processor, which is coupled to the transceiver. The processor is configured to perform the operations corresponding to the method in the second aspect of the present disclosure.

According to an aspect of the present disclosure, there is provided a computer-readable storage medium, the computer-readable storage medium having computer programs stored thereon that, when executed by a processor, implement the method in the first aspect or the second aspect of the present application.

According to an aspect of the present disclosure, there is provided a network device in a wireless communication system. The network device includes a receiving module configured to receive control information from a base station. Further, the network device includes a determination module configured to determine forwarding state and/or resource information based on the control information. Further, the network device includes a control module configured to control the forwarding of signals based on the determined forwarding state and/or resource information.

According to an aspect of the present disclosure, there is provided a base station in a wireless communication system. The base station includes an acquisition module configured to acquire control information. Further, the base station includes a transmitting module configured to transmit the control information to a network device in the communication system, the control information being used for instructing the network device to determine forwarding state and/or resource information based on the control information and control the forwarding of signals based on the determined forwarding state and/or resource information.

The beneficial effects achieved by the provided technical solutions will be described below by specific optional embodiments and will not be repeated here.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The detailed description and discussion of one or more embodiments of the subject matter of the present application will be set forth to those of ordinary skill in the art in the following description with reference to the accompanying drawings.

FIG. 1 illustrates an example diagram of a wireless network according to various embodiments of the present disclosure;

FIG. 2a illustrates an example diagram of a transmission path according to an embodiment of the present disclosure;

FIG. 2b illustrates an example diagram of a reception path according to an embodiment of the present disclosure;

FIG. 3a illustrates an example diagram of a UE according to an embodiment of the present disclosure;

FIG. 3b illustrates an example diagram of a gNB according to an embodiment of the present disclosure;

FIG. 4 illustrates a diagram of an example scenario according to an embodiment of the present disclosure;

FIG. 5 illustrates a flowchart of an example method according to an embodiment of the present disclosure:

FIG. 6 illustrates an example diagram of determining the actual starting time of uplink forwarding according to an embodiment of the present disclosure;

FIG. 7 illustrates an example diagram of determining the actual ending time of downlink forwarding according to an embodiment of the present disclosure;

FIG. 8 illustrates an example diagram of determining the actual starting time of downlink forwarding according to an embodiment of the present disclosure;

FIG. 9 illustrates an example diagram of determining the actual ending time of uplink forwarding according to an embodiment of the present disclosure;

FIG. 10 illustrates a schematic structure diagram of an electronic device according to an embodiment of the present disclosure, and

FIG. 11 illustrates a block diagram illustrating a structure of a base station according to an embodiment of the present disclosure.

Throughout the accompanying drawings, the same or similar reference numerals and signs indicate the same or similar elements.

### DETAILED DESCRIPTION

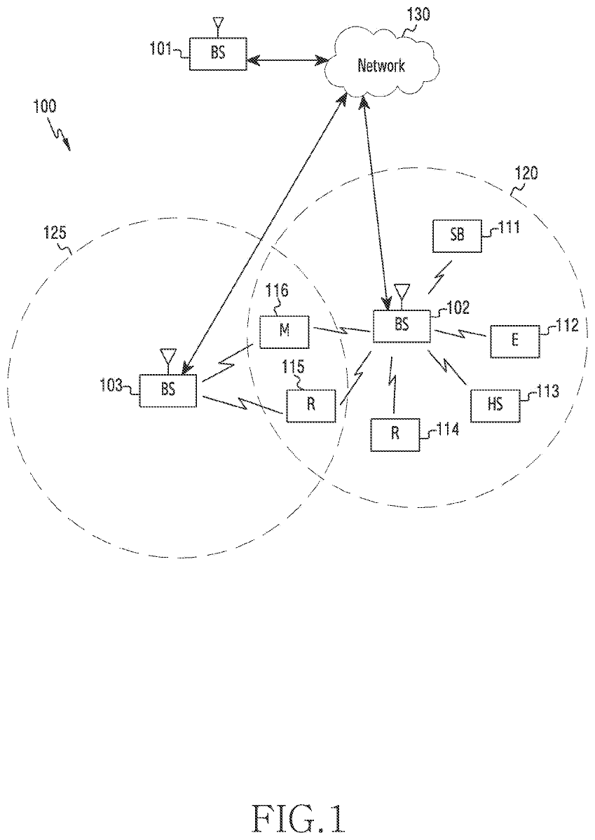

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a.” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The technical solutions of the embodiments of the present disclosure can be applied to various communication systems, such as: global system for mobile communications (GSM) system, code division multiple access (CDMA) system, wideband code division multiple access (WCDMA) system, general packet radio service (general packet radio service (GPRS), long term evolution (LTE) system, LTE frequency division duplex (FDD) system, LTE time division duplex (TDD), universal mobile telecommunication system (UMTS), worldwide interoperability for microwave access (WiMAX) communication system, fifth generation (5th generation, 5G) system, or new radio (new radio, NR), etc. In addition, the technical solutions of the present disclosure embodiments can be applied to future-oriented communication technologies.

FIG. 1 through FIG. 11, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. The gNB 101 communicates with the gNB 102 and gNB 103. The gNB 101 also communicates with at least one Internet Protocol (IP) network 130, such as the Internet, a private IP network, or other data network.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a plurality of first User Equipments (UEs) within a coverage area 120 of the gNB 102. The plurality of first UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to the network 130 for a plurality of second UEs within the coverage area 125 of the gNB 103. The plurality of second UEs include a UE 115 and a UE 116. In some embodiments, one or more of gNBs 101-103 can communicate with each other and with UEs 111-116 using 5G, Long Term Evolution (LTE), LTE-A. WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of a wireless network 100, it may make various changes to FIG. 1. The wireless network 100 can include any number of gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. Furthermore, gNBs 101, 102 and/or 103 can provide access to other or additional external networks, such as external telephone networks or other types of data networks.

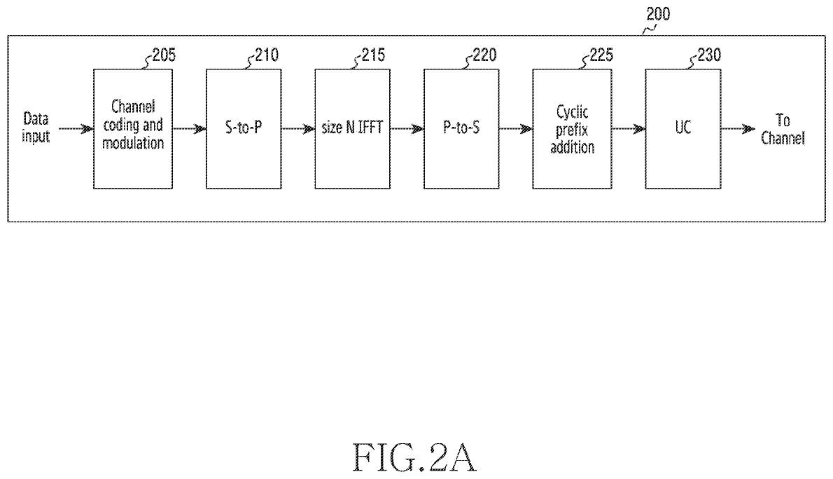

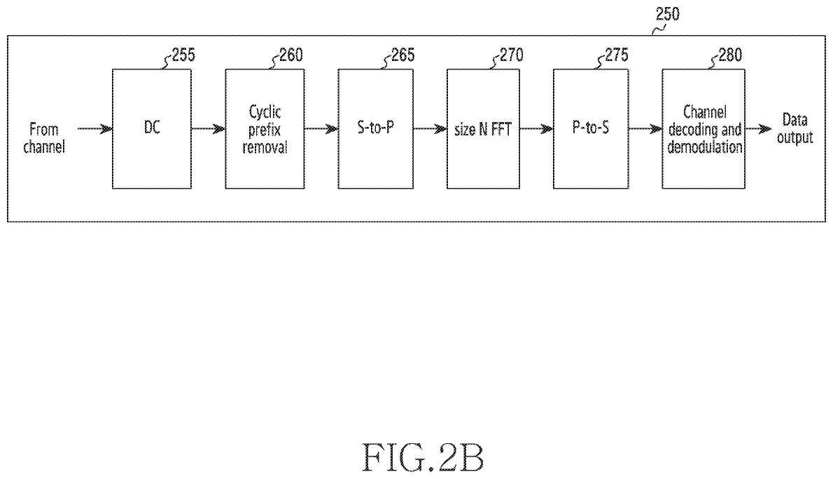

FIG. 2a illustrates an example wireless transmitting paths according to the present disclosure. In the following description, the transmission path 200 can be described as being implemented in a gNB, such as gNB 102. However, it should be understood that the transmission path 200 can be implemented in a UE.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

FIG. 2b illustrates an example wireless receiving paths according to the present disclosure. In the following description, the reception path 250 can be described as being implemented in a UE, such as UE 116. However, it should be understood that the reception path 250 can be implemented in a gNB. In some embodiments, the reception path 250 is configured to support codebook designs and structures for systems with 2D antenna arrays as described in embodiments of the present disclosure.

The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

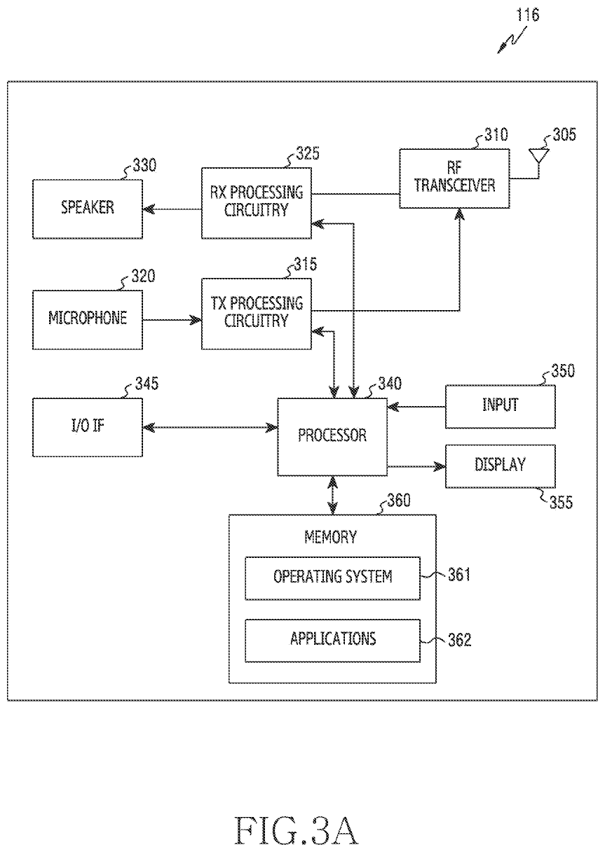

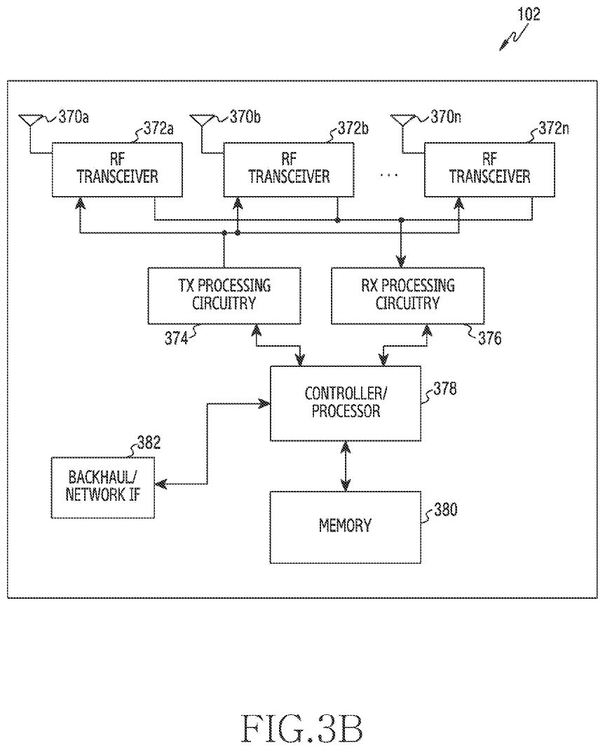

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface (IF) 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In one embodiment of the present disclosure, one or more of the plurality of antennas 370a-370n include a 2D antenna array, gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of commands, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of a gNB 102, it may make various changes to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It will be appreciated that the embodiments of the present disclosure provide solutions that may be applicable to, but are not limited to, the wireless networks described above.

The technical solutions of the present disclosure and how the technical solutions of the present disclosure solve the above technical problems will be described in detail hereinafter with reference to specific embodiments. The following several specific embodiments may be combined with each other, and the same or similar concepts or processes may not be described in detail in some embodiments. The embodiments of the present disclosure will be described below with reference to the accompanying figures. The text and accompanying drawings in the following description are provided by way of example only to assist the reader in understanding the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In order to make the purpose, technical solutions and advantages of the present disclosure more clearly understood, the following is a further detailed description of the present disclosure with reference to the accompanying drawings and examples of embodiments.

In communication systems, to enhance the network coverage, the signals from a base station to a user equipment (UE) or from a UE to a base station can be forwarded via a network device. The name of the network device that forwards signals will not be limited in the embodiments of the present disclosure, and may be called a repeater, an amplifier, a smart repeater, a relay, a relay device or other names. For convenience of description, the embodiments of the present disclosure will be described by taking a repeater as an example.

In a wireless communication system, when the wireless channel environment between a terminal and a base station is poor, for example, due to the presence of obstructions, deep fading will occur in the wireless channel, so that the transmission rate of slave terminals is greatly reduced and the user experience is affected. This situation is common in cell edge users. To enhance the coverage of 5G wireless communication systems, one implementation is to build repeaters at the edge of a cell (or, in areas with poor signal coverage in the cell). Generally, the repeaters are arranged on two sides, i.e., the base station side and the terminal side. For the downlink of the base station, the repeater receives, on the base station side, radio frequency (RF) signals from the base station on the base station side. These RF signals pass through the amplifier built in the repeater, and the amplified signals are transmitted to the terminal device on the terminal side of the repeater; or, these RF signals are reflected by the intelligent surface placed in the repeater, which is equivalent to forward the RF signals to the terminal device on the terminal side of the repeater. For the downlink of the base station, the repeater receives, on the terminal side, RF signals from the terminal device. These RF signals pass through the amplifier built in the repeater, and the amplified signals are transmitted to the base station on the base station side of the repeater; or, these RF signals are reflected by the intelligent surface placed in the repeater, which is equivalent to forward the RF signals to the base station on the base station side of the repeater.

The present disclosure provides a novel repeater. Unlike the existing repeaters that only have a function for receiving and forwarding RF signals, the repeater provided by the present disclosure includes two functions, i.e., a function for receiving and forwarding RF signals, and a function for receiving the control information from the base station.

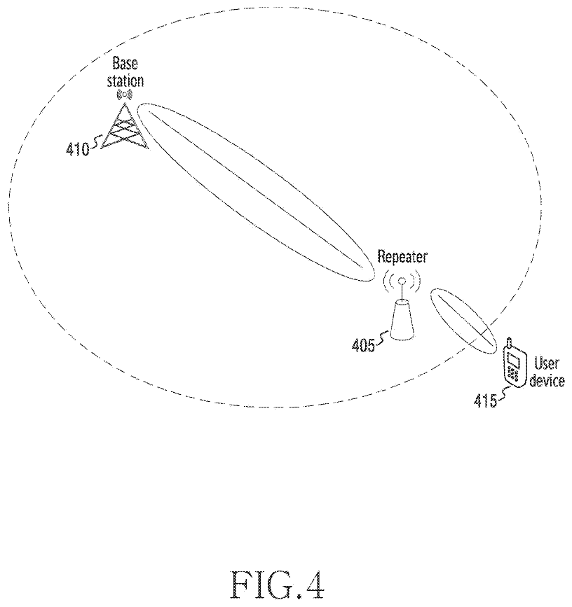

FIG. 4 illustrates a diagram of an example scenario according to an embodiment of the present disclosure.

As shown in FIG. 4, the repeater 405 can forward the signals from the base station 410 to the UE 415, can forward the signals from the UE 415 to the base station 410, and can receive the control information from the base station 410.

In the configuration of the repeater 405, the specific implementation of the module for receiving and forwarding RF signals may be a network-controlled repeater RF amplifier (NCR-Amplifier) or a network-controlled repeater reconfiguration intelligent surface (NCR-RIS) based on the electromagnetic metamaterial technology, etc., which are collectively called a repeater forwarder (also referred to as a forwarder) in the present disclosure. The following description will be given by taking the repeater forwarder being an NCR-Amplifier as an example. Unless otherwise specified, the NCR-Amplifier may be equivalently replaced with the NCR-RIS in the following embodiments. In addition, the module for receiving the control information from the base station is called a network-controller repeater mobile terminal (NCR-MT), or called a repeater mobile terminal (also referred to as a terminal). The following description will be given by taking the module for receiving the control information from the base station being an NCR-MT as an example.

The control information from the base station received by the NCR-MT may be information used for adjusting the parameters of the NCR-Amplifier and/or controlling the transmission of the NCR-Amplifier.

In one embodiment of the present disclosure, the repeater 405 may represent an NCR-MT, or an NCR-Amplifier or a combination of the both NCT-MT and NCR-Amplifier. In addition, the NCR-MT may also be equivalently interpreted as a UE, that is, it may be equivalently interpreted as a terminal device (UE).

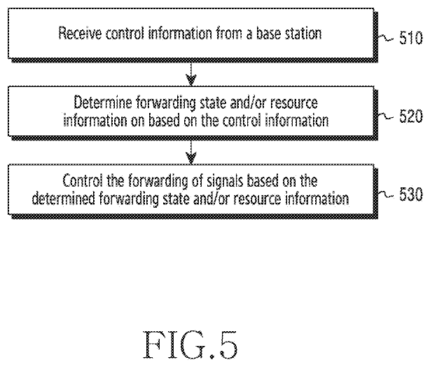

FIG. 5 illustrates an exemplary flowchart of a method performed by a network device in a wireless communication system according to an embodiment of the present disclosure.

As shown in FIG. 5, the method performed by a network device for forwarding signals includes steps 510 to 530.

At step 510, the network device receives control information from a base station.

At step 520, the network device determines forwarding state and/or resource information based on the control information.

At step 530, the network device controls the forwarding of signals based on the determined forwarding state and/or resource information.

Specifically, repeater forwarding is classified into uplink forwarding and downlink forwarding. The uplink forwarding is that the repeater receives an uplink signal transmitted by the terminal and forwards the uplink signal to the base station, wherein the forwarded uplink signal is an RF signal that is the same as the uplink signal received by the repeater except for amplitude or completely the same as this uplink signal. The downlink forwarding is that the repeater receives a downlink signal transmitted by the base station and forwards the downlink signal to the terminal, wherein the forwarded downlink signal is an RF signal that is the same as the downlink signal received by the repeater except for amplitude or completely the same as this downlink signal. The repeater requires a certain switching time between uplink forwarding and downlink forwarding. This is because it will take a certain time to switch from one forwarding mode to another forwarding mode as the uplink forwarding and downlink forwarding involve different components in some repeater implementations. In addition, since the slot boundaries of uplink and downlink frames in an actual system are not aligned, to avoid the time overlap between uplink forwarding and downlink forwarding, the switching time between uplink forwarding and downlink forwarding also needs to be taken into consideration. In addition to the state of uplink and/or downlink forwarding, the repeater may also in an idle/deactivated state. When there is no need for network coverage enhancement, the repeater is configured to be in the deactivated state, so that the purpose of saving energy and reducing inter-cell interference can be achieved.

Specifically, the forwarding state includes at least one of uplink forwarding, downlink forwarding, forwarding on state and forwarding off state.

The forwarding on state of the forwarding state may be interpreted as the repeater being in the forwarding state and being able to perform uplink forwarding and/or downlink forwarding, or may be interpreted as the activation of the downlink forwarding state when the repeater is switched from uplink forwarding to downlink forwarding, or may be interpreted as the activation of the uplink forwarding state when the repeater is switched from downlink switching to uplink forwarding.

The forwarding off state of the forwarding state may be interpreted as the repeater being in the deactivated state and doing not perform any forwarding operation, or may be interpreted as the deactivation of the uplink forwarding state when the repeater is switched from uplink forwarding to downlink forwarding, or may be interpreted as the deactivation of the downlink forwarding state when the repeater is switched from downlink switching to uplink forwarding.

The network-side control information may be the high-layer signaling, switching control information MAC CE, downlink control information, etc., received by the repeater. Furthermore, the high-layer signaling, MAC CE and downlink control information received by the repeater may be the configuration information (second configuration information) for the NCR-Amplifier received by the NCR-MT, or the high-layer signaling, MAC CE and downlink control information received by the repeater may also be the configuration information (first configuration information) for the terminal received by the NCR-MT. There is an association relationship between the configuration information for the terminal and the configuration information for the NCR-Amplifier. That is, the repeater can acquire the configuration of the NCR-Amplifier according to the configuration of the terminal.

In the configuration and transmission method of the repeater shown in the present disclosure, the repeater may determine different forwarding states according to the network-side control information, and/or time-domain/frequency-domain positions and time-domain/frequency-domain resources corresponding to different forwarding states. The base station may realize the switching between different forwarding states of the repeater by configuring the network-side control information. That is, the repeater may switch the forwarding state according to the control information to optimize the communication network. Thus, the power consumption of the repeater and/or the interference between neighboring cells is reduced on the premise of ensuring the coverage capability of cells.

By configuring the forwarding state and resources of the repeater, the method provided in this embodiment can more efficiently utilize resources and improve the power efficiency of the repeater.

In one embodiment, before executing the step 530 of controlling the forwarding of signals based on the determined forwarding state and/or resource information, the method further includes:
determining the forwarding state based on the state of the mobile terminal that processes the control information in the network device.

The forwarding state may be the forwarding state of the NCR-Amplifier.

Specifically, the repeater may determine, according to the state of the NCR-MT, whether the NCR-Amplifier is in the forwarding on state or forwarding off state. At least one of the following situations may be included: when the NCR-MT is in an idle state, determining that NCR-Amplifier is in the forwarding off state; when the NCR-MT is in a discontinuous reception inactive state, determining that NCR-Amplifier is in the forwarding off state: when the NCR-MT is configured on a flexible time-domain symbol, determining that the NCR-Amplifier is in the forwarding off state; and when the NCR-MT is not in any one of the above states (the idle state, the discontinuous reception inactive state, and being configured on the flexible time-domain symbol), determining that the NCR-Amplifier is in the forwarding on state.

In the embodiment of the present disclosure, the forwarding state of the forwarder is correspondingly determined according to the state of the mobile terminal in the repeater, that is, the repeater itself can realize of the switching of the forwarding state by configuring the mobile terminal, thereby optimizing the communication network, and reducing the power consumption and/or the interference between neighboring cells on the premise of ensuring the coverage capability of cells.

In one embodiment, the repeater may also determine the resource information of the forwarder according to the resource information of the mobile terminal.

Specifically, the repeater determines the starting time of a radio frame of downlink forwarding according to the starting time of the downlink frame of the terminal, and/or determines the starting time of a radio frame of uplink forwarding according to the starting time of the uplink frame of the terminal. For example, the starting time of the radio frame of downlink forwarding of the repeater is the same as the starting time of the downlink frame of the NCR-MT. That is, the starting time when the repeater performs downlink forwarding should use the starting point of the downlink frame of the NCR-MT or the starting point of slots/half slots in the downlink frame of the NCR-MT or the starting point of symbols in the downlink frame of the NCR-MT as a reference starting point. The “downlink” may be replaced with “uplink” in the above examples, and it will not be repeated here. This design can ensure the synchronization between the NCR-Amplifier link and the NCR-MT link of the repeater, thereby avoiding the conflict caused by the overlap of time-frequency resources.

In one embodiment, when the resource information includes frequency-domain information, the step 520 of determining forwarding state and/or resource information based on the control information may include: determining, based on the control information, a frequency-domain resource corresponding to the uplink forwarding and/or downlink forwarding.

Specifically, the repeater determines a frequency-domain resource for uplink forwarding and/or downlink forwarding according to the network-side control information. Optionally, the frequency-domain resource where the repeater performs uplink forwarding and/or downlink forwarding is a default value.

The meaning of the frequency-domain resource at least includes at least one of or a combination of more than two of the following: a carrier, a bandwidth part (BWP), a physical resource block group (RBG) and a physical resource block (PRB).

In a specific implementation, the control information received by the repeater may include indication information related to the frequency-domain resource, and the frequency-domain resource for uplink forwarding and/or downlink forwarding is determined by using the indication information. Specifically, the high-layer signaling and/or the MAC CE and/or the downlink control information received by the NCR-MT include an indication of the frequency-domain resource for the uplink forwarding and/or downlink forwarding of the NCR-Amplifier. For example, it may include an indication of the carrier for the uplink forwarding and/or downlink forwarding of the NCR-Amplifier. For another example, it may include an indication of the BWP for the uplink forwarding and/or downlink forwarding of the NCR-Amplifier.

In another specific implementation the frequency-domain resource where the repeater performs uplink forwarding and/or downlink forwarding is a default physical resource. For example, the repeater may perform uplink forwarding and/or downlink forwarding on the carrier where the NCR-MT resides. For another example, the repeater may perform uplink forwarding on an active uplink BWP of the NCR-MT and perform downlink forwarding on an active downlink BWP of the NCR-MT. For another example, the repeater performs uplink forwarding and/or downlink forwarding on a fixed bandwidth.

In the embodiment of the present disclosure, the repeater can control the forwarding of signals by using the frequency-domain resource determined based on the control information or the default frequency-domain resource, so that the power consumption of the repeater or the inter-cell interference can be effectively reduced.

In one embodiment, when the resource information includes time-domain information, the step 520 of determining forwarding state and/or resource information based on the control information may include: determining, based on the control information, a time-domain resource corresponding to forwarding on and/or forwarding off.

Specifically, the repeater may acquire a time-domain resource for forwarding on and forwarding off according to the network-side control information, respectively.

The time-domain resource at least includes at least one of or a combination of more than two of the following: one or more slots, one or more radio frames, and one or more time-domain symbols.

Specifically, a duration (the time-domain resource in the corresponding state) may be determined according to the starting time and ending time of forwarding. The forwarding may at least include one of or a combination of two of the following: uplink forwarding and downlink forwarding.

The network-side control information at least includes one of or a combination of more than two of the following: network-side control information (first configuration information) for the configuration of the NCR-MT, and network-side control information (second configuration information) for the configuration of the NCR-Amplifier.

In the embodiment of the present disclosure, the repeater can control the forwarding of signals by using the time-domain resource determined based on the control information, so that the power consumption of the repeater or the inter-cell interference can be effectively reduced.

In one embodiment, when the control information includes the first configuration information and the second configuration information, there is an association relationship between the first configuration information and the second configuration information.

Optionally, the association relationship includes an association relationship between the parameter and/or state of the mobile terminal configured by the first configuration information and the forwarding state of the forwarder configured by the second configuration information.

When the network-side control information is the network-side control information for the configuration of the NCR-MT, the network-side control information or the parameter/state of the NCR-MT configured by the network-side control information is associated with the configuration information of forwarding of the NCR-Amplifier. For example, the network-side control information configures the time-domain symbol of the NCR-MT to be uplink or uplink. The association between the both may be as follows: the uplink symbol of the NCR-MT indicates that the NCR-Amplifier performs uplink forwarding, while the downlink symbol of the NCR-MT indicates that the NCR-Amplifier performs downlink forwarding.

In one embodiment, the determining, based on the control information, a time-domain resource corresponding to forwarding on and/or forwarding off includes: determining the forwarding on time and/or the forwarding off time based on the indication information of the forwarding on time in the control information.

Specifically, the indication information of the forwarding on time may be the NCR-Amplifier fowarding on time indication received by the NCR-MT, and the repeater may determine the forwarding on time according to the received NCR-Amplifier forwarding on time indication.

The forwarding on time indication may indicate that the NCR-Amplifier performs forwarding on one or more slots/radio frames/time-domain symbols, and the forwarding may include at least one of uplink forwarding and downlink forwarding.

When the forwarding on time indication may indicate both the forwarding on time and the forwarding off time, the repeater determines the forwarding on time and the forwarding off time according to the received NCR-Amplifier forwarding on time indication.

For example, the forwarding on time indication may indicate a time unit to start forwarding among a plurality of time units in a bit mapping manner. For example, a bit sequence x₁x₂ . . . x_{N} with a length of N indicates a unit time for activating NCR-Amplifier forwarding among N time units. When xᵢ₌₁, it indicates that the i^{th} time unit among the N time units is the time unit for activating NCR-Amplifier forwarding; and, when xᵢ₌₀, it indicates that the i^{th} time unit among the N time units is the time unit for deactivating NCR-Amplifier forwarding. The time unit means at least one of the following: a slot, a radio frame, a time-domain symbol, a slot group consisting of a plurality of slots, a radio frame group consisting of a plurality of radio frames, and a time-domain symbol group consisting of a plurality of time-domain symbols. Indicating the unit time for activating NCR-Amplifier forwarding among N time units by using the bit sequence x₁x₂ . . . x_{N} with a length of N may be a periodic indication. That is, the NCR-MT also needs to receive the period of indicating the time unit for activating forwarding, and determine the time unit for activating NCR-Amplifier forwarding in each period according to the bit sequence x₁x₂ . . . x_{N}.

Specifically, the forwarding on time may be associated with the forwarding off time, and the repeater may determine the forwarding off time according to the association and the received NCR-Amplifier fowarding on time indication. For example, the repeater determines the forwarding on time according to the NCR-Amplifier forwarding on time indication, and uses the non-indicated fowarding on time within the effective duration indicated by the forwarding on time as the forwarding off time: or, the repeater determines the forwarding on time according to the NCR-Amplifier forwarding on time indication, and uses the non-indicated forwarding on time in the period indicated by the forwarding on time as the forwarding off time in this period.

The specific way of receiving, by the NCR-MT, the NCR-Amplifier forwarding on time indication may be at least one of the following: receiving, by the NCR-MT, a high-layer signal to obtain the NCR-Amplifier forwarding on time indication; receiving, by the NCR-MT, downlink control informant to obtain the NCR-Amplifier forwarding on time indication; and, receiving, by the NCR-MT, an MAC CE to obtain the NCR-Amplifier forwarding on time indication.

When the NCR-MT receives downlink control information to obtain the NCR-Amplifier forwarding on time indication, the downlink control information may be downlink control information common to a user group, for example, downlink control information for the configuration or paging of a group of repeaters; or, the downlink control information may also be downlink control information exclusive to a user, for example, downlink control information for the configuration of a single repeater.

In the embodiment of the present disclosure, the repeater can control the forwarding of signals by using the forwarding on time indication in the control information, so that the power consumption of the repeater or the inter-cell interference can be effectively reduced.

In one embodiment, the determining, based on the control information, a time-domain resource corresponding to forwarding on and/or forwarding off includes:
determining the forwarding on time based on the indication information of triggering forwarding on in the control information.

Specifically, the forwarding on time may be determined based on the time when the indication information of triggering forwarding on is received. The indication information of triggering forwarding on may be an indication of triggering NCR-Amplifier forwarding on received by the NCR-MT, and an indication of triggering NCR-Amplifier forwarding on received by the repeater. The forwarding on time can be determined by the indication.

The method of determining the forwarding on time may specifically include: when the repeater is in the fowarding off state, using the Nth time unit after the time unit where the NCR-MT receives the indication of triggering NCR-Amplifier forwarding on (i.e., the time unit where a PDCCH carrying the indication of NCR-Amplifier fowarding on is received) as the starting time of NCR-Amplifier forwarding on. The time unit may be one of the following: a radio frame, a slot, a time-domain symbol, a half frame and a half slot, and N is a positive integer greater than or equal to 1 and may be a configured value or a fixed value.

When the repeater is in the forwarding on state, if the NCR-MT receives the indication of triggering NCR-Amplifier forwarding on, the NCR-Amplifier is kept in the forwarding on state. On this basis, the NCR-MT may further acquire an indication of the NCR-Amplifier forwarding on duration or a default forwarding on duration (recorded as M time units). After the repeater determines the starting time of NCR-Amplifier forwarding on, M time units after the starting time are used as the NCR-Amplifier forwarding on time; or otherwise, the repeater is the forwarding off state.

More specifically, the indication of triggering NCR-Amplifier forwarding on may be indication information of triggering the NCR-Amplifier forwarding on of one or more repeaters. For example, a bit sequence x₁x₂ . . . x_{N} with a length of N indicates that the NCR-Amplifier forwarding of N repeaters is in the on or off state. When xᵢ₌₁, it indicates that the i^{th} repeater among the N repeaters triggers to activate the NCR-Amplifier forwarding; and, when xᵢ₌₀, it indicates that the NCR-Amplifier forwarding of the i^{th} repeater among the N repeaters is in the off state, where N is a positive integer greater than or equal to 1 and the value of N may be configured or a fixed value (for example, N=1 indicates that the forwarding function of a single repeater is triggered by 1 bit). When N is greater than 1, the repeater also needs to acquire the relative identifier (recorded as i) in the N repeaters, indicating that the repeater is the i^{th} repeater among the N repeaters. For another example, the repeater determines, according to the indication of triggering NCR-Amplifier forwarding on carried in the downlink control information common to a user group, whether to activate the NCR-Amplifier forwarding function of the repeater, wherein the downlink control information common to a user group may be common downlink control information configured for a group of repeaters and may be used to activate the forwarding function of this group of repeaters. For another example, the indication information includes the identity of the repeater (NCR-Amplifier or NCR-MT) and the corresponding activation triggering indication, indicating that the forwarding function of the repeater with the specific identity is turned on. The identity may be an international mobile subscriber identity (TMSI), a radio network temporary identity (RNTI), etc. Preferably, the related indication information may be transmitted by a paging message.

The specific way of receiving, by the NCR-MT, an indication of triggering NCR-Amplifier forwarding on may be at least one of the following: receiving, by the NCR-MT, a high-layer signal to obtain the indication of triggering NCR-Amplifier forwarding on; receiving, by the NCR-MT, downlink control informant to obtain the indication of triggering NCR-Amplifier forwarding on; and, receiving, by the NCR-MT, an MAC CE to obtain the indication of triggering NCR-Amplifier forwarding on.

When the NCR-MT receives downlink control information to obtain the indication of triggering NCR-Amplifier forwarding on, the downlink control information may be downlink control information common to a user group, for example, downlink control information for the configuration or paging of a group of repeaters; or, the downlink control information may also be downlink control information exclusive to a user, for example, downlink control information for the configuration of a single repeater. When the NCR-MT receives a high-layer signaling to obtain the indication of triggering NCR-Amplifier forwarding on, the high-layer signaling may be a paging message.

In the embodiment of the present disclosure, the repeater can control the forwarding of signals by using the indication of triggering forwarding on in the control information, so that the power consumption of the repeater or the inter-cell interference can be effectively reduced.

In one embodiment, the determining, based on the control information, a time-domain resource corresponding to forwarding on and/or forwarding off includes: determining the forwarding off time based on the indication information of triggering forwarding off in the control information.

Specifically, the forwarding off time may be determined based on the time when the indication information of triggering forwarding off is received. The indication information of triggering forwarding on may be an indication of triggering NCR-Amplifier forwarding off received by the NCR-MT, and an indication of triggering NCR-Amplifier forwarding off received by the repeater. The forwarding off time can be determined by the indication.

The method of determining the forwarding off time may specifically include: when the repeater is in the forwarding on state, deactivating NCR-Amplifier forwarding from the Nth time unit after the time unit where the NCR-MT receives the indication of triggering NCR-Amplifier forwarding off (e.g., the time unit where a PDCCH carrying the indication of NCR-Amplifier forwarding off is received). The time unit may be one of the following: a radio frame, a slot, a time-domain symbol, a half frame and a half slot; and N is a positive integer greater than or equal to 1 and may be a configured value or a fixed value. When the repeater is in the forwarding off state, if the NCR-MT receives the indication of triggering NCR-Amplifier forwarding off, the NCR-Amplifier is kept in the forwarding off state. More specifically, the indication of triggering NCR-Amplifier forwarding off may indicate that the NCR-Amplifier forwarding of one or more repeaters is in an off state.

In a specific implementation, the indication of triggering NCR-Amplifier forwarding on and the indication of triggering NCR-Amplifier forwarding off may be different states in the same indication domain. For example, a bit sequence x₁x₂ . . . x_{N} with a length of N indicates that the NCR-Amplifier fowarding of N repeaters is in the on state or off state. When xᵢ₌₁, it indicates that the i^{th} repeater among the N repeaters triggers to activate the NCR-Amplifier forwarding; and, when xᵢ₌₀, it indicates that the NCR-Amplifier forwarding of the i^{th} repeater among the N repeaters is in the off state, where N is a positive integer greater than or equal to 1 and the value of N is configured or a fixed value (for example, when N=1, the forwarding function of a single repeater is triggered by 1 bit). When N is greater than 1, the repeater also needs to acquire the relative identifier (recorded as i) in the N repeaters, indicating that the repeater is the i^{th} repeater among the N repeaters.

For another example, the repeater determines, according to the indication of NCR-Amplifier forwarding off carried in the downlink control information common to a user group, whether to deactivate the NCR-Amplifier forwarding function of this repeater, wherein the downlink control information common to a user group may be common downlink control information configured for a group of repeaters, and may be used to deactivate the forwarding function of this group of repeaters.

For another example, the indication information includes the identity (e.g., TMSI, RNTI, etc.) of the repeater (NCR-Amplifier or NCR-MT) and the corresponding deactivation triggering indication, indicating that the fowarding function of the repeater with a specific identity is turned off. Preferably, such indication information may be transmitted by a paging message.

The specific way of receiving, by the NCR-MT, an indication of triggering NCR-Amplifier forwarding off may be at least one of the following: receiving, by the NCR-MT, a high-layer signal to obtain the indication of triggering NCR-Amplifier forwarding off; receiving, by the NCR-MT, downlink control informant to obtain the indication of triggering NCR-Amplifier forwarding off; and, receiving, by the NCR-MT, an MAC CE to obtain the indication of triggering NCR-Amplifier forwarding off. Preferably, when the NCR-MT receives downlink control information to obtain the indication of triggering NCR-Amplifier forwarding off, the downlink control information may be downlink control information common to a user group, for example, downlink control information for the configuration or paging of a group of repeaters; or, the downlink control information may also be downlink control information exclusive to a user, for example, downlink control information for the configuration of a single repeater. Preferably, when the NCR-MT receives a high-layer signaling to obtain the indication of triggering NCR-Amplifier forwarding off, the high-layer signaling may be a paging message.

In the embodiment of the present disclosure, the repeater can control the forwarding of signals by using the indication of triggering forwarding off in the control information, so that the power consumption of the repeater or the inter-cell interference can be effectively reduced.

In one embodiment, the determining, based on the control information, a time-domain resource corresponding to forwarding on and/or forwarding off includes: determining the starting time of forwarding on and/or forwarding off based on the reception time of downlink control information and/or control information format in the control information.

The control information format may be a physical downlink control channel (PDCCH) format. Specifically, the NCR-Amplifier forwarding on is triggered according to the specific downlink control information/specific PDCCH format received by the NCR-MT, and the repeater determines the starting time of forwarding on according to the time when the specific downlink control information/specific PDCCH format is received.

The method of determining the starting time of forwarding may include: using the Nth time unit after the time unit where the NCR-MT receives the specific downlink control information/specific PDCCH format as the NCR-Amplifier forwarding on time, wherein the time unit may be a slot or a time-domain symbol, and N is a positive integer greater than or equal to 1 and may be a configured value or a fixed value. The specific downlink control information may be downlink control information common to a user group, for example, downlink control information carried by a PDCCH scrambled with a specific RNTI, wherein the specific RNTI may be the identity configured by the repeater NCR-Amplifier; or, the specific downlink control information may also be downlink control information exclusive to a user, for example, downlink control information exclusive to a user that does not explicitly carry the NCR-Amplifier forwarding on indication but carries the configuration information related to other forwarders.

The above embodiments may be used for triggering the repeater forwarding off. For example, the “on” in the above embodiments is replaced with “off”. That is, the Nth time unit after the time unit where the NCR-MT receives the specific downlink control information/specific PDCCH format is used as the NCR-Amplifier forwarding off time.

In the embodiment of the present disclosure, the repeater can control the forwarding of signals by using the reception time of downlink control information and/or control information format in the control information, so that the power consumption of the repeater or the inter-cell interference can be effectively reduced.

In one embodiment, the determining, based on the control information, a time-domain resource corresponding to forwarding on and/or forwarding off includes: determining, based on the control information, a time unit for uplink forwarding and/or a time unit for downlink forwarding in the time of the forwarding state of forwarding on.

Specifically, the repeater determines the NCR-Amplifier forwarding on time according to first network-side control information, and determines, according to second network-side control information, a time unit where the NCR-Amplifier performs uplink forwarding and a time unit where the NCR-Amplifier performs downlink forwarding in the NCR-Amplifier forwarding on time.

The time unit may be one of the following: a radio frame, a slot, a time-domain symbol, a half frame, and a half slot.

The specific content of the first network-side control information and the specific method of determining the NCR-Amplifier forwarding on time may be as described in other specific implementations of this example.

The second network-side control information may be the network-side control information received by the NCR-MT which is used to configure any one of the time units of NCR-Amplifier forwarding on to be used for uplink forwarding or downlink forwarding, and/or other configuration information associated with determining any one of the time units of NCR-Amplifier forwarding on to be used for uplink forwarding or downlink forwarding. For example, the second network-side control information may be the uplink and downlink configuration information of the terminal received by the NCR-MT, for example, the uplink and downlink configuration of the system message, and/or the semi-static TDD uplink and downlink configuration of the high-layer signaling, and/or the slot format indication (SFI) of the downlink control information, etc. The repeater determines, according to the uplink and downlink configuration of the terminal, any single time unit in the forwarding on time to be used for uplink forwarding or downlink forwarding. For example, when a certain time-domain symbol is a time-domain symbol for forwarding on and is an uplink transmission according to the uplink and downlink configuration of the terminal, uplink forwarding is performed on this time-domain symbol; and, when a certain time-domain symbol is a time-domain symbol for forwarding on and is a downlink transmission according to the uplink and downlink configuration of the terminal, downlink forwarding is performed on this time-domain symbol. For another example, the second network-side control information may also be the NCR-Amplifier forwarding uplink and downlink configuration information received by the NCR-MT, for example, the system message configuration, and/or the high-layer signaling semi-static configuration, and/or the downlink control information configuration, etc. The repeater determines, according to the NCR-Amplifier forwarding uplink and downlink configuration, any time unit in the forwarding on time to be used for uplink forwarding or downlink forwarding. For example, any single time unit in the forwarding on time is configured for uplink forwarding or downlink forwarding in a bit mapping manner. That is, a bit sequence x₁x₂ . . . x_{N} with a length of N indicates N NCR-Amplifier forwarding on time units for uplink forwarding or downlink forwarding, wherein each bit corresponds to one forwarding on time unit. For another example, the second network-side control information may also be the sum of the uplink and downlink configuration information of the terminal received by the NCR-MT and the NCR-Amplifier forwarding uplink and downlink configuration information. For example, when a certain time-domain symbol is a time-domain symbol for forwarding on and is flexible according to the uplink and downlink configuration of the terminal, it is determined as uplink forwarding or downlink forwarding on this time-domain symbol according to the NCR-Amplifier forwarding uplink and downlink configuration.

The specific way of receiving the second network-side control information by the NCR-MT may be at least one of the following: receiving, by the NCR-MT, a high-layer signaling to obtain the second network-side control information; receiving, by the NCR-MT, downlink control information to obtain the second network-side control information: and, receiving, by the NCR-MT, an MAC CE to obtain the second network-side control information.

Preferably, when the NCR-MT receives downlink control information to obtain the second network-side control information, the downlink control information may be downlink control information common to a user group, for example, downlink control information for the configuration or paging of a group of repeaters; or, the downlink control information may also be downlink control information exclusive to a user, for example, downlink control information for the configuration of a single repeater.

In one embodiment, the determining, based on the control information, a time-domain resource corresponding to forwarding on and/or forwarding off includes: determining the uplink forwarding time, the downlink forwarding time and/or the forwarding off time based on the indication information of the uplink forwarding time and/or downlink forwarding time in the control information.

Specifically, the NCR-MT receives an indication of the NCR-Amplifier uplink forwarding time and/or downlink forwarding time, and the repeater determines the uplink forwarding time, the downlink forwarding time and/or the forwarding off time according to the received indication of the NCR-Amplifier uplink forwarding time and/or downlink forwarding time.

Specifically, the indication information of the uplink forwarding time and the downlink forwarding time may be an uplink forwarding/downlink forwarding on time indication, and the indication may indicate a time unit, in one or more time units, where the NCR-Amplifier performs uplink forwarding or downlink forwarding or the forwarding is turned off. The time unit may be one of the following: a radio frame, a slot, a time-domain symbol, a half frame, and a half slot. For example, the uplink/downlink forwarding on indication is used for indicating the format of forwarding in a period of time. That is, the repeater acquires a format index of forwarding in a period of time according to the uplink/downlink forwarding on time indication, and obtains, according to the format index and by table lookup, that the forwarding state of each time-domain symbol in this period of time is uplink forwarding or downlink forwarding, or determines that the forwarding state of each time-domain symbol in this period of time is uplink forwarding, downlink forwarding or forwarding off. Preferably, when the period of time is a slot, the uplink/downlink forwarding on time indication is used for indicating the forwarding format in one slot.

The specific way of receiving the NCR-Amplifier uplink and downlink forwarding time indication by the NCR-MT may be at least one of the following: receiving, by the NCR-MT, a high-layer signal to obtain the NCR-Amplifier uplink and downlink forwarding time indication; receiving, by the NCR-MT, downlink control informant to obtain the NCR-Amplifier uplink and downlink forwarding time indication; and, receiving, by the NCR-MT, an MAC CE to obtain the NCR-Amplifier uplink and downlink forwarding time indication.

Preferably, when the NCR-MT receives downlink control information to obtain the NCR-Amplifier uplink and downlink forwarding time indication, the downlink control information may be downlink control information common to a user group, for example, downlink control information for the configuration or paging of a group of repeaters; or, the downlink control information may also be downlink control information exclusive to a user, for example, downlink control information for the configuration of a single repeater.

In one embodiment, when the resource information includes time-domain information, the step 520 of determining forwarding state and/or resource information based on the control information may include: determining, based on the control information, the switching time between uplink forwarding and downlink forwarding.

Specifically, in the configuration and transmission method of the repeater in the present disclosure, the specific way of determining, by the repeater and according to the network-side control information, time-domain positions and time-domain resources corresponding to different forwarding states may further include: determining, by the repeater and according to the network-side control information, a switching time (first switching time) from uplink forwarding to downlink forwarding and/or a switching time (second switching time) from downlink forwarding to uplink forwarding. The switching time from uplink forwarding to downlink forwarding refers to a time interval between the end of uplink forwarding and the start of downlink forwarding when the NCR-Amplifier does not perform uplink and downlink forwarding; and, the switching time from downlink forwarding to uplink forwarding refers to a time interval between the end of downlink forwarding and the start of uplink forwarding when the NCR-Amplifier does not perform uplink and downlink forwarding. This design can ensure that the NCR-Amplifier has enough time to perform hardware preheating, preparation, switching, etc., so as to switch from one forwarding state to another forwarding state. In the switching time from uplink forwarding to downlink forwarding and the switching time from downlink forwarding to uplink forwarding, the NCR-MT of the repeater may continuously perform uplink transmission and downlink reception. Both the switching time from uplink forwarding to downlink forwarding and the switching time from downlink forwarding to uplink forwarding are non-negative values greater than or equal to 0. Preferably, the switching time from uplink forwarding to downlink forwarding and the switching time from downlink forwarding to uplink forwarding may have the same value. For example, both the time intervals may be 0, indicating that the repeater is switched from uplink forwarding to downlink forwarding or from downlink forwarding to uplink forwarding without any switching time. This situation can be applied to a repeater configuration using an intelligent surface as a forwarder.

The specific way of receiving the NCR-Amplifier uplink and downlink forwarding switching time indication by the NCR-MT may be at least one of the following: receiving, by the NCR-MT, a high-layer signal to obtain the NCR-Amplifier uplink and downlink forwarding switching time indication; receiving, by the NCR-MT, downlink control informant to obtain the NCR-Amplifier uplink and downlink forwarding switching time indication; and, receiving, by the NCR-MT, an MAC CE to obtain the NCR-Amplifier uplink and downlink forwarding switching time indication. Preferably, when the NCR-MT receives downlink control information to obtain the NCR-Amplifier uplink and downlink forwarding switching time indication, the downlink control information may be downlink control information common to a user group, for example, downlink control information for the configuration or paging of a group of repeaters; or, the downlink control information may also be downlink control information exclusive to a user, for example, downlink control information for the configuration of a single repeater.

In the following examples, the “switching time” refers to one or both of the “switching time from uplink forwarding to downlink forwarding” and the “switching time from downlink forwarding to uplink forwarding”.

Specifically, the specific method of determining, by the repeater and according to the network-side control information, the switching time from uplink fowarding to downlink forwarding and the switching time from downlink forwarding to uplink forwarding includes the following situation: the switching time of the repeater is related to the repeater's capability. For example, the NCR-MT of the repeater reports the repeater's capability related to the switching time, and the switching time parameter of the repeater may be determined according to the correspondence between the capability level and the value of the switching time. That is, the switching time determined by the repeater is related to the reported switching time related capability. In one case, the repeater reports that the switching time related capability level A corresponds to a switching time of 0, and the repeater reports that the switching time related capability level B corresponds to a switching time of T (where T is greater than 0), wherein the correspondence between the switching time related capability and the switching time may be obtained by table lookup, and the table may be issued by the network side (for example, the table may be the content in the control information transmitted by the base station).

Optionally, the specific method of determining, by the repeater and according to the network-side control information, the switching time from uplink forwarding to downlink forwarding and the switching time from downlink fowarding to uplink forwarding further include: determining, by the repeater, the switching time according to the network-side control information. For example, the NCR-MT receives the network-side control information for indicating the NCR-Amplifier switching time. Before the repeater acquires the NCR-Amplifier switching time according to the network-side control information indication, the method may further include the following step: reporting the switching time related capability by the repeater: or setting the switching time as a protocol fixed value.

In one embodiment, when the resource information includes time-domain information, the step 520 of determining forwarding state and/or resource information based on the control information may include: determining the actual starting time of uplink forwarding, the actual ending time of uplink forwarding, the actual starting time of downlink forwarding or the actual ending time of downlink forwarding based on the switching time and/or an uplink transmission timing advance.

The uplink transmission timing advance is an uplink transmission timing advance of the mobile terminal that processes the control information in the network device.

Specifically, in the configuration and transmission method of the repeater provided by the present disclosure, the specific way of determining, by the repeater and according to the network-side control information, time-domain positions and time-domain resources corresponding to different forwarding states may further include at least one of the following: the repeater determines the actual starting time of uplink forwarding according to the switching time from downlink forwarding to uplink forwarding and/or the uplink transmission timing advance of the NCR-MT: the repeater determines the actual ending time of downlink forwarding according to the switching time from downlink forwarding to uplink forwarding and/or the uplink transmission timing advance of the NCR-MT; the repeater determines the actual starting time of downlink forwarding according to the switching time from uplink forwarding to downlink forwarding and/or the uplink transmission timing advance of the NCR-MT; and the repeater determines the actual ending time of uplink forwarding according to the switching time from uplink forwarding to downlink forwarding and/or the uplink transmission timing advance of the NCR-MT.

The switching time from downlink forwarding to uplink forwarding and the switching time from uplink forwarding to downlink forwarding may be the same configuration. The determined actual starting time of uplink forwarding/downlink forwarding may be within the configured continuous duration of uplink forwarding/downlink forwarding and not earlier than the configured uplink forwarding/downlink forwarding starting time. For example, if the configured uplink forwarding/downlink forwarding starts on a time-domain symbol with an index of 1 in a slot with an index of i, the repeater determines a duration T_{gap} and uses a moment T_{gap} after the starting boundary of the time-domain symbol with an index of I in the slot with an index of i as the actual starting time. Similarly, the determined actual ending time of uplink forwarding/downlink forwarding may be within the configured continuous duration of uplink forwarding/downlink forwarding and not earlier than the configured uplink forwarding/downlink forwarding ending time. For example, if the configured uplink forwarding/downlink forwarding ends on a time-domain symbol with an index of 1 in a slot with an index of i, the repeater determines a duration T_{gap} and uses a moment T_{gap} before the ending boundary of the time-domain symbol with an index of 1 in the slot with an index of i as the actual ending time.

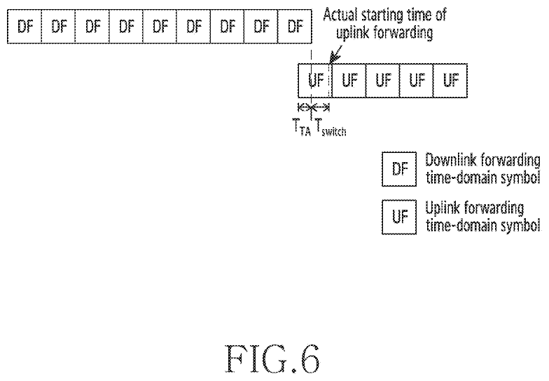

The specific implementation of determining, by the repeater, the actual starting time of uplink forwarding according to the switching time from downlink forwarding to uplink forwarding and/or the uplink transmission timing advance of the NCR-MT may be as follows: if the configured starting symbol of the uplink forwarding of the repeater is a time-domain symbol #1 in a slot #i, the uplink forwarding of the repeater actually starts at a moment T_{gap} after the starting boundary of the time-domain symbol #1 in the slot #i, where T_{gap}=T_{switch}+T_{TA}, T_{switch} is the switching time from downlink forwarding to uplink forwarding, and T_{TA} is the uplink transmission timing advance of the NCR-MT, as shown in FIG. 6.

FIG. 6 illustrates an example diagram of determining the actual starting time of uplink forwarding according to an embodiment of the present disclosure.

In the FIG. 6, when the uplink forwarding frame and the downlink forwarding frame of the repeater are synchronized with the uplink frame and the downlink frame of the NCR-MT, respectively, the influences from the overlap of the uplink frame boundary with the downlink frame boundary and the switching time from the downlink forwarding to uplink forwarding are fully taken into consideration, so that the switching between downlink forwarding and uplink forwarding of the NCR-Amplifier is ensured.

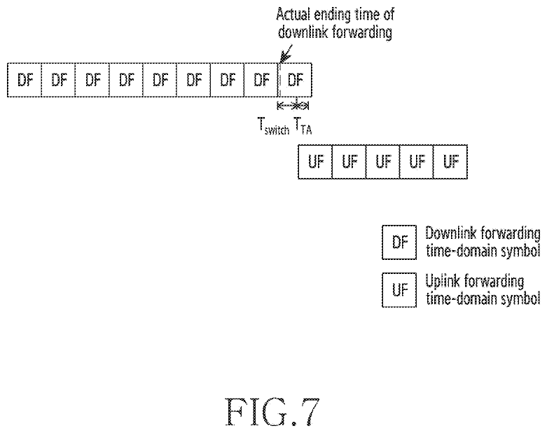

The specific implementation of determining, by the repeater, the actual ending time of downlink forwarding according to the switching time from downlink forwarding to uplink forwarding and/or the uplink transmission timing advance of the NCR-MT may be as follows: if the configured last symbol (ending symbol) of the downlink forwarding of the repeater is a time-domain symbol #1 in a slot #i, the uplink forwarding of the repeater actually ends at a moment Top before the boundary of the time-domain symbol #1 in the slot #i, where T_{gap}=T_{switch}+T_{TA}, T_{switch} is the switching time from downlink forwarding to uplink forwarding, and T_{TA} is the uplink transmission timing advance of the NCR-MT, as shown in FIG. 7.

FIG. 7 illustrates an example diagram of determining the actual ending time of downlink forwarding according to an embodiment of the present disclosure.

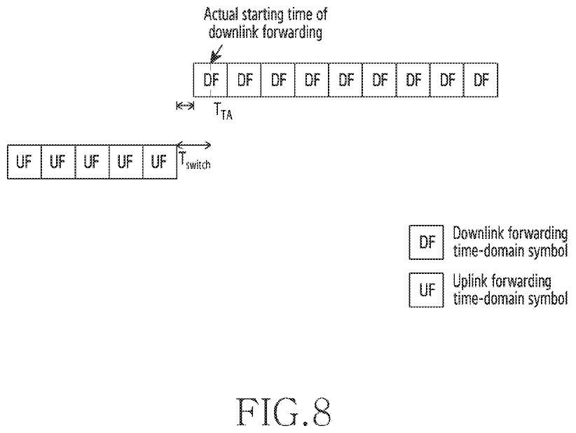

The specific implementation of determining, by the repeater, the actual starting time of downlink forwarding according to the switching time from uplink forwarding to downlink forwarding and/or the uplink transmission timing advance of the NCR-MT may be as follows: if the configured starting symbol of the downlink forwarding of the repeater is a time-domain symbol #1 in a slot #i, the downlink forwarding of the repeater actually starts at a moment T_{gap} after the starting boundary of the time-domain symbol #1 in the slot #i, where T_{gap}=max(T_{switch}−T_{TA}, 0), T_{switch} is the switching time from downlink forwarding to uplink forwarding, TA is the uplink transmission timing advance of the NCR-MT, and max(x, y) means the larger one of x and y, as shown in FIG. 8.

FIG. 8 illustrates an example diagram of determining the actual starting time of downlink forwarding according to an embodiment of the present disclosure.

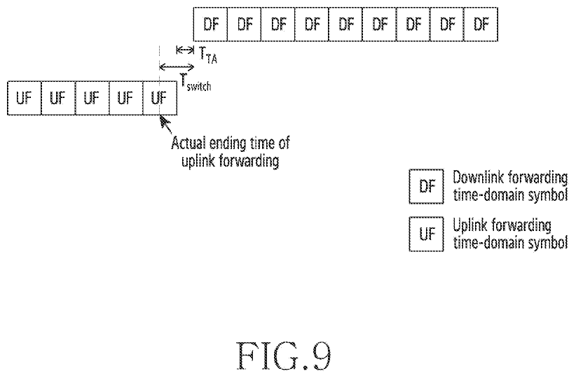

The specific implementation of determining, by the repeater, the actual ending time of uplink forwarding according to the switching time from uplink forwarding to downlink forwarding and/or the uplink transmission timing advance of the NCR-MT may be as follows: if the configured last symbol (ending symbol) of the uplink forwarding of the repeater is a time-domain symbol #1 in a slot #i, the uplink forwarding of the repeater actually ends at a moment T_{gap} before the boundary of the time-domain symbol #1 in the slot #i, where T_{gap}=max(T_{switch}−T_{TA}, 0), T_{switch} is the switching time from downlink forwarding to uplink forwarding, T_{TA} is the uplink transmission timing advance of the NCR-MT, and max(x, y) means the larger one of x and y, as shown in FIG. 9.

FIG. 9 illustrates an example diagram of determining the actual ending time of uplink forwarding according to an embodiment of the present disclosure.

In one feasible embodiment, when the resource information includes time-domain information, the step 520 of determining forwarding state and/or resource information based on the control information may include:
determining, based on the control information, at least one of: an uplink forwarding time unit, a downlink forwarding time unit and an interval between an uplink forwarding time-domain symbol and a downlink forwarding time-domain symbol.

Specifically, in the configuration and transmission method of the repeater provided by the present disclosure, the specific way of determining, by the repeater and according to the network-side control information, time-domain positions and time-domain resources corresponding to different forwarding states may further include: determining, by the repeater and according to the network-side control information, an uplink forwarding time unit, a downlink forwarding time unit and an interval between an uplink forwarding time-domain symbol and a downlink forwarding time-domain symbol.

The interval between the uplink forwarding time-domain symbol and the downlink forwarding time-domain symbol may be one or more time units, or a time interval of a non-integer multiple of time domain symbols. The time unit at least includes one of the following: a time-domain symbol, a slot, a half slot, a radio frame and a subframe. The NCR-Amplifier does not perform uplink and downlink forwarding within the interval, while the NCR-MT of the repeater can continuously perform uplink transmission and downlink reception. This design can ensure that the NCR-Amplifier has enough time to perform hardware preheating, preparation, switching, etc., so as to switch from one forwarding state to another forwarding state, and the switching of the NCR-Amplifier will not affect the normal reception and transmission of the NCR-MT.

The specific way of acquiring, by the repeater, the network-side control information used for determining the uplink forwarding time unit, the downlink forwarding time unit and the interval configuration between the uplink forwarding time-domain symbol and the downlink forwarding time-domain symbol may be at least one of the following: receiving, by the NCR-MT, a high-layer signaling to obtain the network-side control information; receiving, by the NCR-MT, downlink control information to obtain the network-side control information; and, receiving, by the NCR-MT, an MAC CE to obtain the network side control information. When the NCR-MT receives downlink control information to obtain the network-side control information, the downlink control information may be downlink control information common to a user group, for example, downlink control information for the configuration or paging of a group of repeaters; or, the downlink control information may also be downlink control information exclusive to a user, for example, downlink control information for the configuration of a single repeater.

Preferably, the configuration acquired according to the network-side control information by the repeater includes a plurality of consecutive uplink forwarding time-domain symbols/slots, a plurality of consecutive downlink forwarding time-domain symbols/slots, and one or more interval time-domain symbols/slots between consecutive uplink forwarding time domains/gaps and consecutive downlink forwarding time-domain symbols/slots. For example, the repeater determines, according to the uplink/downlink configuration and/or SFI received by the NCR-MT, the uplink forwarding time unit, the downlink forwarding time unit and the interval between the uplink forwarding time-domain symbol and the downlink forwarding time-domain symbol: the NCR-Amplifier performs downlink forwarding on a slot/time-domain symbol configured as downlink, performs uplink forwarding on a slot/time-domain symbol configured as uplink, and uses a slot/symbol configured as flexible as the interval between the uplink forwarding time-domain symbol and the downlink forwarding time-domain symbol. For another example, the NCR-MT receives the downlink control information to obtain a fowarding format indication, and then obtains a forwarding format to be adopted in the NCR-Amplifier forwarding on time according to the indicated index value by table lookup, wherein the forwarding format contains the position of the uplink forwarding time-domain symbol, the position of the downlink forwarding time-domain symbol and the interval between the uplink forwarding time-domain symbol and the downlink forwarding time-domain symbol in a fixed duration (e.g., slot). For another example, the NCR-MT receives a high-layer signaling to acquire the position of the uplink forwarding time-domain symbol, the position of the downlink forwarding time-domain symbol and the interval between the uplink forwarding time-domain symbol and the downlink forwarding time-domain symbol in a fixed duration (e.g., slot).

Based on the above embodiments, the present disclosure further provides a method performed by a base station in a communication system, including: acquiring control information; and transmitting the control information to a network device in the communication system, the control information being used for instructing the network device to determine fowarding state and/or resource information based on the control information and control the forwarding of signals based on the determined forwarding state and/or resource information.

In one embodiment, the base station may configure the control information, wherein the forwarding state includes at least one of uplink forwarding, downlink forwarding, forwarding on state and forwarding off state.

In one embodiment, the configuring the control information includes: receiving the switching time related capability reported by the network device, the switching time being a switching time between uplink forwarding and downlink forwarding; and configure the control information based on the capability.

Specifically, when the base station configures the control information based on the switching time related capability reported by the network device, the correspondence between the capability and the switching time may be recorded in form of a table; and, when the network device receives the control information, the switching time currently corresponding to the switching time related capability may be determined according to the correspondence recorded in the control information. Different capabilities related to the switching time in the network device may be distinguished by capability levels. For example, the switching time corresponding to the capability level A is 0, and the switching time corresponding to the capability level B is T (T is greater than 0).

In the embodiment of the present disclosure, by configuring the network-side control information, the base station can realize the switching between different forwarding states of the repeater to optimize the communication network, so that the power consumption of the repeater and/or the interference between neighboring cells is reduced on the premise of ensuring the coverage capability of cells.

Based on the same principle as the method provided in the embodiments of the present disclosure, an embodiment of the present disclosure further provides a network device in a communication system. The network device may include a receiving module, a determination module and a control module.

The receiving module is configured to receive control information from abase station: the determination module is configured to determine forwarding state and/or resource information based on the control information: and the control module is configured to control the forwarding of signals based on the determined forwarding state and/or resource information.

In one feasible embodiment, the forwarding state includes at least one of uplink forwarding, downlink forwarding, forwarding on state and forwarding off state.

In one feasible embodiment, when the determination module is configured to determine forwarding state and/or resource information based on the control information, the determination module is specifically configured to execute at least one of the following: determining, based on the control information, a frequency-domain resource corresponding to the forwarding state of uplink forwarding and/or downlink forwarding; determining, based on the control information, a time-domain resource corresponding to forwarding on and/or forwarding off; determining, based on the control information, the switching time between uplink forwarding and downlink forwarding; determining, based on the switching time and/or an uplink transmission timing advance, at least one of the actual starting time of uplink forwarding, the actual ending time of uplink forwarding, the actual starting time of downlink forwarding and the actual ending time of downlink forwarding; and determining, based on the control information, at least one of an uplink forwarding time unit, a downlink forwarding time unit and an interval between an uplink forwarding time-domain symbol and a downlink forwarding time-domain symbol; wherein the uplink transmission timing advance is an uplink transmission timing advance of a mobile terminal that processes the control information in the network device.

In one feasible embodiment, the control information includes indication information related to the frequency-domain resource; and, the frequency-domain resource includes at least one of a carrier, a bandwidth part (BWP), a physical resource block group (RBG) and a physical resource block (PRB).

In one feasible embodiment, the determination module being configured to determine, based on the control information, a time-domain resource corresponding to forwarding on and/or forwarding off includes at least one of the following: determining the forwarding on time and/or the forwarding off time based on the indication information of the forwarding on time in the control information; determining the forwarding on time based on the indication information of triggering forwarding on in the control information; determining the forwarding off time based on the indication information of triggering forwarding off in the control information; determining the starting time of forwarding on and/or forwarding off based on the reception time of downlink control information and/or control information format in the control information; determining, based on the control information, a time unit for uplink forwarding and/or a time unit for downlink forwarding in the time of the forwarding state of forwarding on: and determining the uplink forwarding time, the downlink fowarding time and/or the forwarding off time based on the indication information of the uplink forwarding time and/or downlink fowarding time in the control information.

In one feasible embodiment, the switching time includes at least one of a first switching time from uplink forwarding to downlink forwarding and a second switching time from downlink forwarding to uplink forwarding.

In one feasible embodiment, the switching time is related to the switching time related capability reported by the network device.

In one feasible embodiment, the interval between the uplink forwarding time-domain symbol and the downlink forwarding time-domain symbol is at least one time unit or a time interval of a non-integer multiple of time domain symbols.

In one feasible embodiment, the time-domain resource includes at least one time unit, and the time unit includes at least one of a time-domain symbol, a slot, a half slot, a radio frame and a subframe.

In one embodiment, the network device includes a forwarder for forwarding signals and a mobile terminal for processing the control information; wherein the control information comprises at least one of first configuration information for the mobile terminal and second configuration information for the forwarder; and, when the control information comprises the first configuration information and the second configuration information, there is an association relationship between the first configuration information and the second configuration information.

In one embodiment, when the control information includes the first configuration information and the second configuration information, there is an association relationship between the first configuration information and the second configuration information.

Optionally, the association relationship includes an association relationship between the parameter and/or state of the mobile terminal configured by the first configuration information and the forwarding state of the forwarder configured by the second configuration information.

In one embodiment, the control information is received by at least one of the following: receiving a high-layer signaling; receiving downlink control information; and receiving switching control information MAC CE.

In one feasible embodiment, the downlink control information is downlink control information common to a user group or downlink control information exclusive to a user.

Based on the same principle as the method provided in the embodiments of the present disclosure, an embodiment of the present disclosure further provides a base station in a communication system. The base station may include an acquisition module and a transmitting module.

The acquisition module is configured to acquire control information; and the transmitting module is configured to transmit the control information to a network device in the communication system, the control information being used for instructing the network device to determine forwarding state and/or resource information based on the control information and control the forwarding of signals based on the determined forwarding state and/or resource information.

In one embodiment, when the acquisition module is configured to acquire control information, the acquisition module is specifically configured to configure the control information; wherein the forwarding state comprises at least one of uplink forwarding, downlink forwarding, forwarding on state and forwarding off state.

In one feasible embodiment, when the acquisition module is configured to configure the control information, the acquisition module is specifically configured to: receive the switching time related capability reported by the network device, the switching time being a switching time between uplink forwarding and downlink forwarding; and configure the control information based on the capability.

Based on the same principle as the method provided in the embodiments of the present disclosure, an embodiment of the present disclosure provides an electronic device, including: a transceiver; and, a processor, which is coupled to the transceiver and configured to implement the method provided in any one of optional embodiments of the present disclosure. Optionally, the electronic device may be implemented as the above network device, e.g., the repeater. The network device includes: a transceiver; and, a processor, which is coupled to the transceiver and configured to execute the method executed by a network device for forwarding signals provided in any one of optional embodiments of the present disclosure. Optionally, the electronic device may be implemented as a base station. The base station includes: a transceiver: and, a processor, which is coupled to the transceiver and configured to execute the method executed by a base station provided in any one of optional embodiments of the present disclosure.

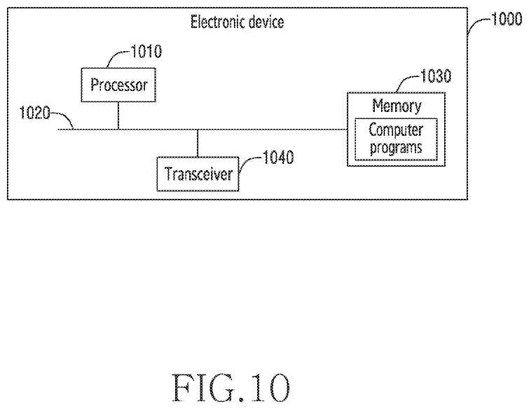

FIG. 10 illustrates a schematic structure diagram of an electronic device according to an embodiment of the present disclosure. Furthermore, the electronic device may correspond to the UE of FIG. 1 and FIG. 3A.

As shown in FIG. 10, wherein the electronic device 1000 shown in FIG. 10 includes: a processor 1010 and a memory 1030. Wherein, the processor 1010 communicates with the memory 1030, e.g., via a bus 1020. Optionally, the electronic device 1000 may also include a transceiver 1040, which may be used for data interaction between this electronic device and other electronic devices, such as data transmission and/or data reception. It is to be noted that, in practical disclosures, the number of the transceiver 1040 is not limited to one, and the structure of the electronic device 4000 does not constitute any limitation to the embodiments of the present disclosure.

The processor 1010 may be a central processing unit (CPU), a general-purpose processor, a digital signal processor (DSP), a disclosure specific integrated circuit (ASIC), a field programmable gate array (FPGA) or other programmable logic devices, a transistor logic device, a hardware component or any combination thereof. The processor can implement or execute various exemplary logic blocks, modules and circuits described in the disclosure of the present invention. The processor 1010 may also be a combination of computing functions, such as a combination of one or more microprocessors, a combination of a DSP and a microprocessor, and so on.

The bus 1020 can include a path for delivering information among the above components. The bus 1020 may be a peripheral component interconnect (PCI) bus, an extended industry standard architecture (EISA) bus, etc. The bus 1020 may be divided into an address bus, a data bus, a control bus, and so on. For ease of illustration, only one bold line is shown in FIG. 10, but does not indicate that there is only one bus or type of bus.

The memory 1030 may be a read only memory (ROM) or other types of static storage devices that can store static information and instructions, a random access memory (RAM) or other types of storage devices that can store information and instructions. The memory 1030 may also be electrically erasable programmable read only memory (EEPROM), compact disc read only memory (CD-ROM) or other optical disk storage, optical disk storage (including compressed compact disc, laser disc, compact disc, digital versatile disc, blue-ray disc, etc.), magnetic disk storage medium or other magnetic storage device, or any other medium capable of carrying or storing desired program code in the form of instructions or data structures and capable of being accessed by a computer, but not limited to this.

The memory 1030 is configured to store disclosure program codes (computer programs) for executing the solutions of the present disclosure, and the processor 1010 controls the execution. The processor 1010 is configured to execute disclosure program codes stored in the memory 1030 to implement what is shown in the foregoing method embodiment.

It should be understood that although each of steps in the flowchart of the figures are sequentially shown as the arrows, these steps are not necessarily performed in the order indicated by the arrows. Unless explicitly stated herein, the execution of these steps is not strictly limited, and they can be performed in other orders. Moreover, at least a part of the steps in the flowcharts of the accompanying drawings may include multiple sub-steps or multiple stages, and these sub-steps or stages are not necessarily executed at the same time, but may be executed at different times, and the execution sequence is also. It does not have to be performed sequentially, but may be performed alternately or alternately with other steps or at least a portion of sub-steps or stages of other steps.

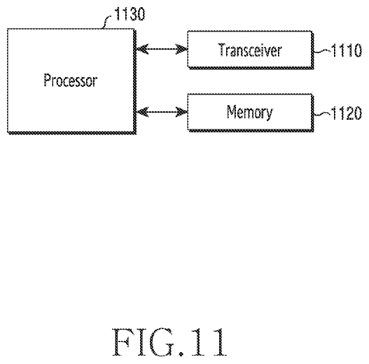

FIG. 11 is a block diagram illustrating a structure of a base station according to an embodiment of the disclosure. Furthermore, the base station may correspond to base station of FIG. 1 and FIG. 3B.

As shown in FIG. 11, the base station according to an embodiment may include a transceiver 1110, a memory 1120, and a processor 1130. The transceiver 1110, the memory 1120, and the processor 1130 of the base station may operate according to a communication method of the base station described above. However, the components of the base station are not limited thereto. For example, the base station may include more or fewer components than those described above. In addition, the processor 1130, the transceiver 1110, and the memory 1120 may be implemented as a single chip. Also, the processor 1130 may include at least one processor.

The transceiver 1110 collectively refers to a base station receiver and a base station transmitter, and may transmit/receive a signal to/from a terminal or a network entity. The signal transmitted or received to or from the terminal or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the base station. Also, the memory 1120 may store control information or data included in a signal obtained by the base station. The memory 1120 may be a storage medium, such as read-only memory (ROM), random access memory (RAM), a hard disk, a CD-ROM, and a DVD, or a combination of storage media.

The processor 1130 may control a series of processes such that the base station operates as described above. For example, the transceiver 1110 may receive a data signal including a control signal transmitted by the terminal, and the processor 1130 may determine a result of receiving the control signal and the data signal transmitted by the terminal.

The above are only some embodiments of the present disclosure. It should be pointed out that for those skilled in the art, some improvements and modifications can be made without departing from the principles of the present disclosure. These improvements and modifications should also be regarded as the protection scope of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a network controlled repeater (NCR) in a wireless communication system, the method comprising:
receiving, by an NCR mobile terminal (NCR-MT) from a base station, control information;
identifying a forwarding state of an NCR-amplifier and a resource corresponding to the forwarding state based on the control information;
receiving, by the NCR-MT from the base station, a downlink signal; and
forwarding, by the NCR-amplifier to a user equipment (UE), the downlink signal on the identified resource, in case that the forwarding state is a forwarding-on state.

2. The method of claim 1, further comprising:
identifying that the forwarding state of the NCR-amplifier is a forwarding-off state for a flexible symbol.

3. The method of claim 1, further comprising:
in case that the control information includes an indication of triggering the forwarding-on state, identifying that the forwarding state of the NCR-amplifier is the forwarding-on state.

4. The method of claim 3,
wherein the identified resource includes a time domain resource comprising at least one of a starting time or a duration of forwarding.

5. The method of claim 4,
wherein the control information includes first control information and second control information,
wherein the first control information is for identifying the forwarding state of the NCR-amplifier, and
wherein the second control information is for identifying the time domain resource.

6. A network controlled repeater (NCR) in a wireless communication system, the NCR comprising:
an NCR mobile terminal (NCR-MT); and
an NCR-amplifier,
wherein the NCR is configured to:
receive, by an NCR mobile terminal (NCR-MT) from a base station, control information,
identify a forwarding state of an NCR-amplifier and a resource corresponding to the forwarding state based on the control information,
receive, by the NCR-MT from the base station, a downlink signal, and
forward, by the NCR-amplifier to a user equipment (UE), the downlink signal on the identified resource, in case that the forwarding state is a fowarding-on state.

7. The NCR of claim 6, wherein the NCR is further configured to:
identify that the forwarding state of the NCR-amplifier is a forwarding-off state for a flexible symbol.

8. The NCR of claim 6, wherein the NCR is further configured to:
in case that the control information includes an indication of triggering the forwarding-on state, identify that the forwarding state of the NCR-amplifier is the fowarding-on state.

9. The NCR of claim 8,
wherein the identified resource includes a time domain resource comprising at least one of a starting time or a duration of forwarding.

10. The NCR of claim 9,
wherein the control information includes first control information and second control information,
wherein the first control information is for identifying the forwarding state of the NCR-amplifier, and
wherein the second control information is for identifying the time domain resource.

11. A method performed by a network controlled repeater (NCR) in a wireless communication system, the method comprising:
receiving, by an NCR mobile terminal (NCR-MT) from a base station, control information;
identifying a forwarding state of an NCR-amplifier and a resource corresponding to the forwarding state;
receiving, by the NCR-amplifier from a user equipment (UE), an uplink signal; and
forwarding, by the NCR-amplifier to the base station, the uplink signal on the identified resource, in case that the forwarding state is a forwarding-on state.

12. The method of claim 11, further comprising:
identifying that the forwarding state of the NCR-amplifier is a forwarding-off state for a flexible symbol.

13. The method of claim 11, further comprising:
in case that the control information includes an indication of triggering the forwarding-on state, identifying that the forwarding state of the NCR-amplifier is the forwarding-on state.

14. The method of claim 13,
wherein the identified resource includes a time-domain resource comprising at least one of a starting time or a duration of forwarding.

15. The method of claim 14,
wherein the control information includes first control information and second control information,
wherein the first control information is for identifying the forwarding state of the NCR-amplifier, and
wherein the second control information is for identifying the time domain resource.

16. A network controlled repeater (NCR) in a wireless communication system, the NCR comprising:
an NCR mobile terminal (NCR-MT); and
an NCR-amplifier,
wherein the NCR is configured to:
receive, by an NCR mobile terminal (NCR-MT) from a base station, control information,
identify a forwarding state of an NCR-amplifier and a resource corresponding to the forwarding state,
receive, by the NCR-amplifier from a user equipment (UE), an uplink signal, and
forward, by the NCR-amplifier to the base station, the uplink signal on the identified resource, in case that the fowarding state is a fowarding-on state.

17. The NCR of claim 16, further comprising:
identify that the forwarding state of the NCR-amplifier is a forwarding-off state for a flexible symbol.

18. The NCR of claim 17, further comprising:
in case that the control information includes an indication of triggering the forwarding-on state, identify that the forwarding state of the NCR-amplifier is the fowarding-on state.

19. The NCR of claim 18,
wherein the identified resource includes a time-domain resource comprising at least one of a starting time or a duration of forwarding.

20. The NCR of claim 16,
wherein the control information includes first control information and second control information,
wherein the first control information is for identifying the forwarding state of the NCR-amplifier, and
wherein the second control information is for identifying a time domain resource.
